(19) United States
(12) Patent Application Publication
(10) Pub. No.: US 2009/0109948 A1
(43) Pub. Date: Apr. 30, 2009

(54) RADIO COMMUNICATION DEVICE FOR GENERATING AND TRANSMITTING DATA, RADIO COMMUNICATION DEVICE FOR RECEIVING AND DECODING DATA, METHOD FOR TRANSMITTING DATA AND METHOD FOR RECEIVING DATA

(75) Inventor: Hans BAUERNFEIND, Nuernberg (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/926,762

(22) Filed: Oct. 29, 2007

(51) Int. Cl. H04J 1/00

(52) U.S. Cl. 370/343

(57) ABSTRACT

In various embodiments of the invention, a radio communication device for transmitting data, a radio communication device for receiving data, a method for transmitting data and a method for receiving data are provided. In an embodiment of the invention, a radio communication device for generating and transmitting data is provided, transmitting the data in two adjacent frequency portions. The radio communication device includes a data generating circuit and a transmitter circuit.

### BACKGROUND

Embodiments of the invention relate generally to the acquisition of a multi carrier frequency division multiplexing signal and the reception and decoding of the transmitted data.

### SUMMARY OF THE INVENTION

The invention provides a radio communication device for generating and transmitting data using at least two frequency portions, a radio communication device for receiving and decoding the transmitted data, a method for generating data and transmitting data in at least two frequency portions, and method for receiving and decoding the data.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1A shows a spectrum of a paging channel and neighbor channels; and a reception window with frequency error;

FIG. 1B shows a spectrum of a partially received paging channel with an unwanted portion from neighbor channel;

FIG. 2 shows a method for transmitting data, according to an embodiment of the invention;

FIG. 3 shows a spectrum of a paging message transmitted on two frequency portions according to an embodiment of the invention;

FIG. 4 shows a radio communication device for transmitting data according to an embodiment of the invention;

FIG. 5 shows a radio communication device for receiving data according to an embodiment of the invention;

FIG. 6 shows a method for receiving and decoding data according to an embodiment of the invention;

FIG. 7 shows a further method for receiving and decoding data according to an embodiment of the invention;

FIG. 8A shows a spectrum of a paging channel and neighbor channels; and a reception window with frequency error according to an embodiment of the invention;

FIG. 8B shows a spectrum of paging channels after filtering by the reception window; according to an embodiment of the invention;

FIG. 8C shows a spectrum of a reconstructed paging channel according to an embodiment of the invention;

FIG. 9 shows an example with two adjacent paging channels according to an embodiment of the invention; and

FIG. 10 shows an example of a paging message transmitted on three channels according to an embodiment of the invention.

### DESCRIPTION

While being immune against timing errors, multi-carrier modulation methods such as orthogonal frequency division multiple access (OFDM) are quite sensitive against frequency errors due to the narrow bandwidth of the sub-channels.

The frequency errors do not play a big role when the UE is in conversation with the network, i.e. transmitting and receiving data on a sufficiently regular basis, because frequency errors can be assessed and adjusted continuously.

In Radio Resource Control (RRC) Idle Mode, the user equipment (UE) is only in loose contact with the network; it is only receiving paging messages from the network on a regular basis. The interval between two such receptions can last several seconds. During this time, the channel properties and hence the frequency offset can change significantly, for example, due to the movement of the UE causing a Doppler shift.

The normal countermeasure to frequency errors would be to re-assess the frequency offset by reception and evaluation of a known signal, such as frequency correction or synchronization channels, and adjust the frequency offset using this value. However, this would prolong the time in idle mode during which the UE is active, which has adverse effects on battery load and stand-by time. Determination of the frequency offset only by means of the paging channel will not work reliably, since due to the unknown frequency error unwanted portions of signals with unknown contents from neighboring channels arrive at the wanted signal, thus making it unusable.

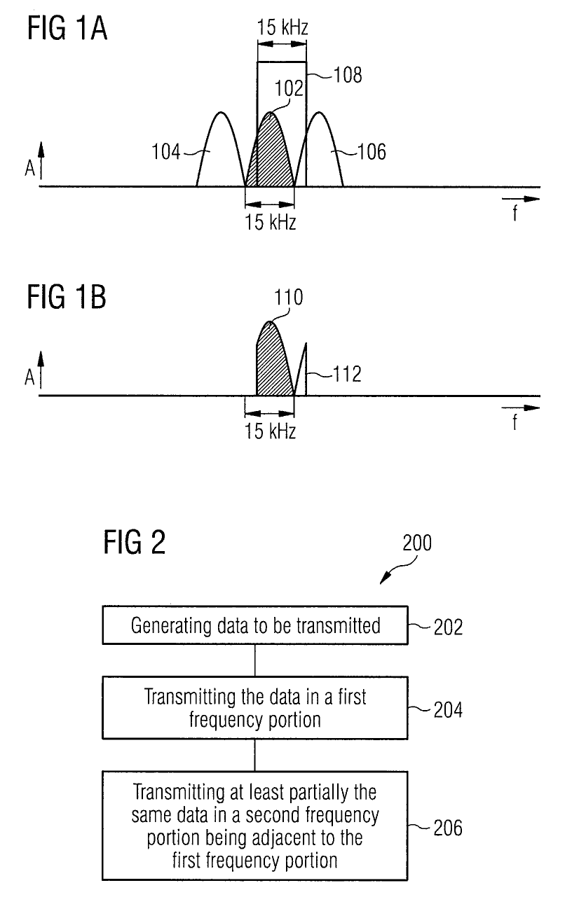

FIG. 1A shows exemplarily a spectrum of three sub-channels of a multi-carrier system, as e.g. an OFDM system. In an embodiment of the invention, “f” denotes the frequency and “A” the amplitude. The figure shows a paging channel 102 with a bandwidth of 15 kHz and two neighboring channels 104 and 106, also having a bandwidth of 15 kHz each. The spectrum of the transmission is not sufficiently frequency synchronized with a receiving circuit which has a 15 kHz reception window 108 for a channel and a frequency error that may be a frequency offset as shown in FIG. 1A.

FIG. 1B illustrates the consequence of the frequency error. The lower part of the transmitted spectrum 102 is cut and instead of receiving this spectrum 102, a portion of the higher neighboring channel 112 is rececived. This means that on the one hand, not enough spectral information might be received in order to decode the data or the message, respectively, and on the other hand, interfering spectral power is received, disturbing additionally the demodulation and decoding of the data.

Thus, according to an embodiment of the invention, and as illustrated in FIG. 2, a method for transmitting data is provided. FIG. 2 shows in 202, that, according to this embodiment, data to be transmitted is generated. In 204, the data is transmitted at least partially in a first frequency portion; and, in 204, the same data is at least partially transmitted in a second frequency portion being adjacent to the first frequency portion.

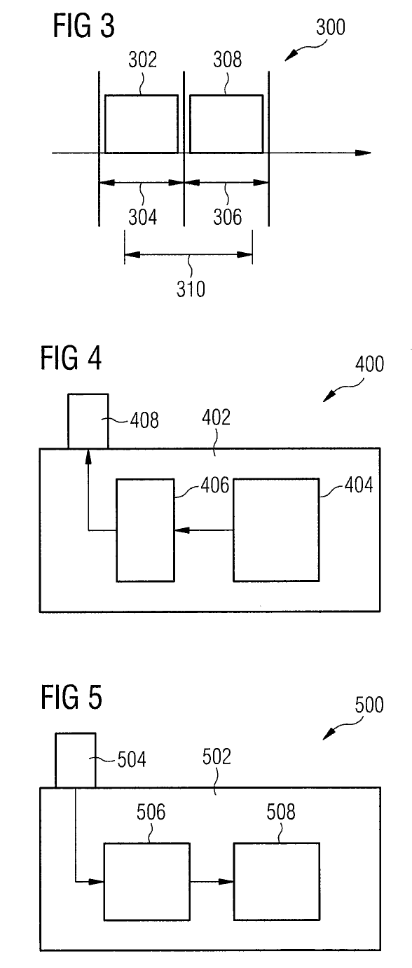

This is also illustrated in FIG. 3. The data, which have to be transmitted are firstly generated such that a frequency spectrum results that spans the spectrum 302. Based on the same data a signal with a spectrum 308 is generated and transmitted in the second frequency portion 306 adjacent to the first frequency portion 304. The spectrum 308 is nearly the same spectrum as the spectrum 302, except of a frequency offset of at least the bandwidth of the frequency portion 304.

Adjacent means in an embodiment of the invention, that there is no other channel or used frequency portion inbetween. However, there may be a spectral gap. In FIG. 3 this is illustrated by the gap between the spectra 302 and 308.

In other words, in effect, the spectrum 302 is duplicated but shifted by a frequency offset and transmitted in the frequency portions 304 and 306, respectively.

As explained further below in more detail, on receiver side, the transmitted frequency portions 304 and 306 are cut by a reception window that has, e.g., a bandwidth as indicated by the arrow 310 in FIG. 3; and the maintaining received spectral parts of these frequency portions 304 and 306 are recomposed.

According to an embodiment of the invention, the generation of the data to be transmitted includes generating at least one message containing the data to be transmitted. Usually, the generation of messages is ruled by a protocol of a communication standard of a communication system. The data of a message may also be a fill pattern or a synchronization pattern.

According to an embodiment, the generation of the data to be transmitted contains generating at least one communication setup message; and the data contains communication setup data. A communication setup message may e.g. be a message to setup a communication link, wherein a communication link may be a data connections or data call, a speech call, and may be bi- or uni-directional. The message to setup a connection or a call may also be intended to send data about the state of a connection or call, system information or user equipment (UE) information generated and sent on a regular or irregular, e.g. event-driven basis. The state of a connection may—besides of the typical connection data known by a skilled person—also include e.g. position information.

The setup message may be, according to an embodiment, a paging message. The generation of the data to be transmitted, thus, may contain generating at least one paging message; and the data contains paging data.

The first and second frequency portions 304 and 306, respectively, may be frequency channels, frequency sub-channels, frequency slots or any other specified frequency range.

According to an embodiment, the data are transmitted in accordance with a multi-frequency carrier method.

According to an embodiment, the data are transmitted in accordance with a frequency division multiple access method.

In an embodiment of the invention, the data are transmitted in accordance with an orthogonal frequency division multiple access method. This includes also methods as e.g. discrete wavelet transformation frequency division multiple access (DWT-OFDM) or also Flash-OFDM (Fast Low-latency Access with Seamless Handoff-Orthogonal Frequency Division Multiplexing).

According to an embodiment, the first frequency portion 304 and the second frequency portion 306 are sub-channels of a frequency channel containing the first frequency portion 304 and the second frequency portion 306.

In an embodiment of the invention, the sub-channels are communication setup channels.

In an embodiment of the invention, the sub-channels are paging channels.

Embodiments of the invention may be generalized in that the spectral components of the data signal as e.g. contained in the bandwidth 302 are transmitted in n frequency portions, as e.g. shown above for the case n=2 with the first frequency portion 304 or the second frequency portion 306, such that the spectral components can be fully reconstructed on receiver side. I.e. that the received signal can be re-composed such that the bandwidth containing all spectral components of the original signal is obtained by the reception of parts of one or more out of the n frequency portions and that the data can be demodulated without spectral losses. The reception of the signal is explained further below in more detail.

The more frequency portions are used for transmitting the data, the more freedom is obtained in respect to the frequency error. Using three frequency portions results in a symmetrical condition if there is no systematic frequency error. I.e. the error may vary in both directions for the same amount without a pre-configuration of a frequency offset for the reception window.

According to an embodiment, the data are transmitted at least partially in a third frequency portion being adjacent to the first frequency portion 304 or the second frequency portion 306. This would correspond to the case n=3.

Embodiments of the invention may be implemented on different communication devices or facilities, respectively.

According to an embodiment, the method is carried out by a satellite-based radio communication device.

According to another embodiment of the invention, the method is carried out by a mobile radio communication device.

According to an embodiment, the method is carried out by a mobile radio base station.

Embodiments of the invention may also be applied to different communication standards or systems, respectively.

In an embodiment of the invention, the data are transmitted in accordance with a Third Generation Partnership Project communication system.

The Third Generation Partnership Project communication system may be e.g. a Universal Mobile Telecommunications System (UMTS)-system or a system related to or at least partially based on UMTS.

Thus, according to an embodiment, the data are transmitted in accordance with a Universal Mobile Telecommunications System communication system.

According to a further embodiment, the data are transmitted in accordance with a Long Term Evolution Universal Mobile Telecommunications System communication system.

In general, the embodiments explained above are applicable to the methods and devices presented in the following.

According to an embodiment of the invention, a radio communication device is provided containing a data generating circuit to generate data to be transmitted, a transmitter circuit to transmit the data in a first frequency portion 304 and to transmit at least partially the same data in a second frequency portion 306 being adjacent to the first frequency portion 304.

An example of such a radio communication device is depicted in FIG. 4 which shows the radio communication device 402 containing the data generating circuit 404 that generates the data to be transmitted. The data is first sent to the transmitter circuit 406 modulating the data onto e.g. two frequencies and radiating the signal in a first frequency portion 304 and a second frequency portion 306 as described above over the antenna 408.

The antenna 408 may be an external antenna, as depicted in FIG. 4 or an internal antenna. The radio communication device 402 may also contain more circuits than depicted in FIG. 4, as known by a skilled person, as e.g. a display and keys with corresponding drivers, power supply, memories, interfaces for wired or wireless communication and for memory extensions, camera and other multimedia circuits, ring tone circuits and loadspeakers, control circuits, etc. Furthermore, the radio communication device 402 may contain one or more receive circuits and one or more decode circuits as described further below.

In an embodiment of the invention, the data generating circuit 404 of the radio communication device 402 is a message generating circuit to generate at least one message comprising the data to be transmitted. The message may contain e.g. binary data, ASCII data or data of another format and may be interpreted as information data, commands, synchronization data, channel organization data or the like according e.g. to a communications protocol.

According to an embodiment, the messages are sent during an idle mode of the communication device 402, e.g in a radio resource control (RRC) idle mode of the communication device 402. In idle mode, messages such as e.g. paging messages are sent with relatively large time periods, e.g. several seconds, inbetween which no messages are sent. Thus, the transmit frequency may vary due to the time variable channel characteristics, e.g. in form of a varying offset from message to message.

However, the offset may be understood in a relative way. That is, a frequency offset may also occur on the receiver side.

The offset usually applies to both channels, i.e. to both frequency portions 304 and 306. As an effect, e.g., the additionally missing spectral parts in the first frequency portion 304 due to an offset are then transmitted in the second frequency portion 306, or vice versa.

According to an embodiment, the data generating circuit 404 of the radio communication device 402 is configured to generate at least one communication setup message; and the data include communication setup data. The communication data may be data as explained above. This may be, e.g., a message to setup a communication link, wherein a communication link may be a data call, a speech call, and may be bi-directional or uni-directional. The message to setup a call may also be intended to send data about the state of a connection, system information or UE information generated and sent on a regular or irregular, e.g. event-driven basis. The state of a connection may—besides the typical connection data known by a skilled person—also include e.g. position information.

According to an embodiment, the data generating circuit 404 of the radio communication device 402 is configured to generate at least one paging message; and the data contain paging data, remotely or locally.

According to a further embodiment, the transmitter circuit 404 of the radio communication device 402 is configured to transmit the data in accordance with a multi-frequency carrier method. However, the invention may be applied generally to any radio communication device being capable to transmit on at least two adjacent frequencies.

The transmitter may transmit the signals on the at least two frequency portions not necessarily contemperaneously. As long as the receiver is capable to relate the spectra belonging together to reconstruct the received spectra to a single spectrum, the point of time of the reception of each spectrum may differ. This capability may be achieved e.g by defining a time window or information obtained by hardware or software.

However, in this case it has to be taken into account that the best effects of the invention is achieved by transmitting the signal with its spectra contemporaneously or quasi-contemporaneously.

According to an embodiment, the transmitter circuit 404 of the radio communication device 402 is configured to transmit the data in accordance with a frequency division multiple access method.

According to an embodiment, the transmitter circuit 504 of the radio communication device 402 is configured to transmit the data in accordance with an orthogonal frequency division multiple access method.

Such orthogonal frequency division multiplexing methods may also be, e.g., Fast Low-latency Access with Seamless Handoff-Orthogonal Frequency Division Multiplexing (Flash-OFDM) or Discrete Wavelet Transformation Orthogonal Frequency Division Multiplexing (DWT-OFDM).

In an embodiment of the invention, the first frequency portion 304 and the second frequency portion 306 are sub-channels of a frequency channel including the first frequency portion 304 and the second frequency portion 306.

In an embodiment of the invention, the sub-channels are communication setup channels.

In an embodiment of the invention, the sub-channels are paging channels.

As described above, the spectral parts may be contained in more than two frequency portions 304, 306.

Thus, according to an embodiment, the transmitter circuit 406 is configured to transmit at least partially the same data in a third frequency portion being adjacent to the first frequency portion 304 or the second frequency portion 306.

In an embodiment of the invention, the radio communication device 402 is configured as a satellite-based radio communication device.

In an embodiment of the invention, the radio communication device 402 is configured as a mobile radio communication device.

According to an embodiment, the radio communication device 402 is configured as a mobile radio base station. The radio communication device 402 may be used for upload (i.e. for example in a transmission direction from the terminal device to the network) and/or download direction (i.e. for example in a transmission direction from the network to the terminal device).

In an embodiment of the invention, the radio communication device 402 is configured in accordance with a Third Generation Partnership Project communication system.

According to an embodiment, the radio communication device 402 is configured in accordance with a Universal Mobile Telecommunications System communication system.

The Third Generation Partnership Project communication system may be e.g. a UMTS-system or a system related to or at least partially based on UMTS.

According to an embodiment, the radio communication device is configured in accordance with a Long Term Evolution Universal Mobile Telecommunications System communication system.

The signal transmitted over at least two frequency portions 304, 306 is received by a radio communication device as e.g. shown in FIG. 5.

According to an embodiment of the invention, a radio communication device 502 is provided containing a receiver circuit 506 to receive data in a first frequency portion 304 and in a second frequency portion 306 being adjacent to the first frequency portion 304; a decoder circuit 506 to decode the data received in the first frequency portion 304 and in the second frequency portion 306 such that by consolidating the received data in the first frequency portion 304 and in the second frequency portion 306, decoded data are determined.

The radio communication device 502 is hence capable to receive the full spectrum of a signal that is transmitted in two different frequency portions as described above. The spectra received in these frequency portions can be recomposed such that the full, single spectrum of the signal is obtained. The recomposed spectrum contains all physical information necessary for decoding the transmitted data.

The radio communication device 502 may contain more circuits than depicted in FIG. 5, as known by a skilled person, as e.g. a display and keys with corresponding drivers, power supply, memories, interfaces for wired or wireless communication and for memory extensions, camera and other multimedia circuits, ring tone circuits and loadspeakers, control circuits, etc. The antenna 504 may be an device-external antenna, as depicted in FIG. 5 or a device-internal antenna. Further the radio communication device 502 may also contain transmit and data generating circuits as described above.

According to an embodiment, the receiver circuit 506 of the radio communication device 502 is a message receiver circuit to receive at least one message containing the data. Messages are usually data organized and specified according to a communications protocol. They may also contain fill data or synchronization data.

According to an embodiment, the data contain communication setup data.

In an embodiment of the invention, the data contain paging data.

In an embodiment of the invention, the receiver circuit 506 of the radio communication device 502 is configured to receive the data in accordance with a multi-frequency carrier method.

According to an embodiment, the receiver circuit 506 of the radio communication device 502 is configured to receive the data in accordance with a frequency division multiple access method.

According to an embodiment of the invention, the receiver circuit of the radio communication device 502 is configured to receive the data in accordance with an orthogonal frequency division multiple access method.

Orthogonal frequency division multiplexing methods include e.g, Flash-OFDM or DWT-OFDM.

According to an embodiment, the first frequency portion 304 and the second frequency portion 306 are sub-channels of a frequency channel including the first frequency portion 304 and the second frequency portion 306.

In an embodiment of the invention, the sub-channels are communication setup channels.

According to an embodiment, the sub-channels are paging channels.

In an embodiment of the invention, the receiver circuit 506 of the radio communication device 502 is further configured to receive data in a third frequency portion being adjacent to the first frequency portion 304 or the second frequency portion 306, as described above. In this case, no pre-defined offset for the reception window is necessary. This case is also illustrated an example further below.

According to an embodiment, the radio communication device 502 is configured as a satellite-based radio communication device.

According to an embodiment, the radio communication device is configured as a mobile radio communication device.

According to an embodiment, the radio communication device is configured as a mobile radio communication terminal device.

According to an embodiment, the radio communication device is configured in accordance with a Third Generation Partnership Project communication system.

According to an embodiment, the radio communication device is configured in accordance with a Universal Mobile Telecommunications System communication system.

According to an embodiment, the radio communication device 502 is configured in accordance with a Long Term Evolution Universal Mobile Telecommunications System communication system.

According to an embodiment, the receiver circuit 506 of the radio communication device 502 is configured to receive data using a center receiver frequency that is arranged between the center frequency of the first frequency portion 304 and the center frequency of the second frequency portion 306. In the case of three frequency portions, the receive center frequency may correspond to the center frequency of the middle frequency portion.

According to an embodiment, the receiver circuit 506 of the radio communication device 502 is configured to receive data using a center receiver frequency that is arranged in the middle between the center frequency of the first frequency portion 304 and the center frequency of the second frequency portion 306. This embodiment takes e.g. into account that the frequency error may vary with the same probability to both sides.

According to an embodiment, the receiver circuit 506 of the radio communication device 502 is configured to receive the data when being in a predetermined receiving mode.

According to an embodiment, the receiver circuit 506 of the radio communication device 502 is configured to receive the data when being in an Idle mode.

According to an embodiment, the decoder circuit 508 of the radio communication device is configured to decode the data using cyclic prefixes which the data contain.

Referring again to FIG. 3 and FIG. 5, according to a further embodiment of the invention, a radio communication device 502 is provided, containing a receiver circuit 506 to receive data in a frequency portion 310 that is larger than a frequency portion 304, 306 being assigned for the transmission of data; a decoder circuit 508 to decode the data received in the frequency portion 310 such that by consolidating the received data in the frequency portion 310, decoded data are determined. By configuring the receive frequency portion equal or larger than the frequency portion 304 or 306, respectively, of the transmitted data it is ensured that all spectral components of the transmitted data are received.

According to an embodiment, the receiver circuit 506 of the radio communication device 502 is a message receiver circuit to receive at least one message containing the data.

According to an embodiment, the data contain communication setup data.

According to an embodiment, the data contain paging data.

In an embodiment of the invention, the receiver circuit 506 of the radio communication device 502 is configured to receive the data in accordance with a multi-frequency carrier method.

In an embodiment of the invention, the receiver circuit 506 of the radio communication device 502 is configured to receive the data in accordance with a frequency division multiple access method.

According to an embodiment, the receiver circuit 506 of the radio communication device 502 is configured to receive the data in accordance with an orthogonal frequency division multiple access method.

According to an embodiment, the frequency portion being assigned for the transmission of data is a sub-channel of a frequency channel including the frequency portion being assigned for the transmission of data.

According to an embodiment, the sub-channel is a communication setup channel.

According to an embodiment, the sub-channel is a paging channel.

According to an embodiment, the radio communication device 502 is configured as a satellite-based radio communication device.

According to an embodiment, the radio communication device 502 is configured as a mobile radio communication device.

According to an embodiment, the radio communication device 502 is configured as a mobile radio communication terminal device.

According to an embodiment, the radio communication device 502 is configured in accordance with a Third Generation Partnership Project communication system.

In an embodiment of the invention, the radio communication device 502 is configured in accordance with a Universal Mobile Telecommunications System communication system.

In an embodiment of the invention, the radio communication device 502 is configured in accordance with a Long Term Evolution Universal Mobile Telecommunications System communication system.

In an embodiment of the invention, the receiver circuit 506 of the radio communication device 502 is configured to receive the data when being in a predetermined receiving mode.

According to an embodiment, the receiver circuit of the radio communication device is configured to receive the data when being in an Idle mode.

According to an embodiment, the decoder circuit of the radio communication device is configured to decode the data using cyclic prefixes which the data contain.

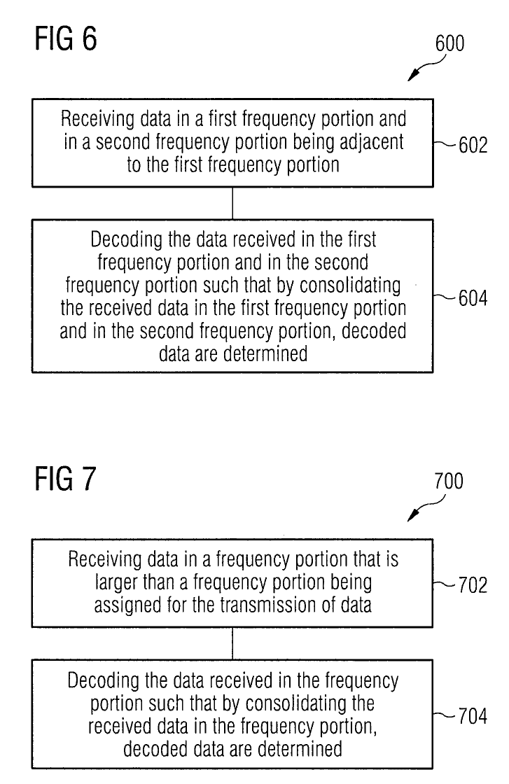

According to an embodiment of the invention, a method for decoding data is provided. FIG. 6 shows a method 600 according to this embodiment. In 602 data is received in a first frequency portion 304 and in a second frequency portion 306 being adjacent to the first frequency portion 304; and in 604 the data received in the first frequency portion 304 and in the second frequency portion 306 is decoded such that by consolidating the received data in the first frequency portion 304 and in the second frequency portion 306, decoded data are determined.

This means that by reception of the two frequency portions 304, 306 all necessary spectral information is gained in order to decode the received data. For that, the received spectra in the two frequency portions 304, 306 are recomposed.

According to an embodiment of the method 600, the receiving data contain receiving at least one message containing the data.

According to an embodiment of the method 600, the data contain communication setup data.

According to an embodiment of the method 600, the data contain paging data.

According to an embodiment of the method 600, the data are received in accordance with a multi-frequency carrier method.

According to an embodiment of the method 600, the data are received in accordance with a frequency division multiple access method.

According to an embodiment of the method 600, the data are received in accordance with an orthogonal frequency division multiple access method.

According to an embodiment of the method 600, the first frequency portion 304 and the second frequency portion 306 are sub-channels of a frequency channel comprising the first frequency portion 304 and the second frequency portion 306.

According to an embodiment of the method 600, the sub-channels are communication setup channels.

According to an embodiment of the method 600, the sub-channels are paging channels.

According to an embodiment of the method 600, the data are received in a third frequency portion 304 being adjacent to the first frequency portion 304 or the second frequency portion 306.

According to an embodiment, the method 600 is carried out by a satellite-based radio communication device.

According to an embodiment, the method 600 is carried out by a mobile radio communication device.

According to an embodiment, the method 600 is carried out by a mobile radio base station.

According to an embodiment, the data are transmitted in accordance with a Third Generation Partnership Project communication system.

According to an embodiment of the invention, the data are transmitted in accordance with a Universal Mobile Telecommunications System communication system.

According to an embodiment of the method 600, the data are transmitted in accordance with a Long Term Evolution Universal Mobile Telecommunications System communication system.

According to an embodiment of the method 600, the data are received using a center receiver frequency that is arranged between the center frequency of the first frequency portion and the center frequency of the second frequency portion.

According to an embodiment of the method 600, the data are received using a center receiver frequency that is arranged in the middle between the center frequency of the first frequency portion and the center frequency of the second frequency portion.

According to an embodiment of the invention, the data are received in a predetermined receiving mode.

According to an embodiment of the method 600, the data are received in an Idle mode, e.g in a radio resource control (RRC) Idle mode.

According to an embodiment of the method 600, the data are decoded using cyclic prefixes which the date contain.

According to a further embodiment of the invention, a method 700 for decoding data is provided, as depicted in FIG. 7. Referring also to FIG. 3, according to this embodiment, as shown in 702, data is received in a frequency portion 310 that is larger than a frequency portion 304, 306 being assigned for the transmission of data. In 704 the data received in the frequency portion 310 is decoded such that by consolidating the received data in the frequency portion 310, decoded data are determined.

According to an embodiment of the method 700, the receiving data contains receiving at least one message containing the data.

According to an embodiment of the method 700, the data contain communication setup data.

According to an embodiment of the method 700, the data contain paging data.

According to an embodiment of the method 700, the data are received in accordance with a multi-frequency carrier method.

According to an embodiment of the method 700, the data are received in accordance with a frequency division multiple access method.

According to an embodiment of the method 700, the data are received in accordance with an orthogonal frequency division multiple access (OFDMA) method.

According to an embodiment, the frequency portion being assigned for the transmission of data is a sub-channel of a frequency channel comprising the frequency portion being assigned for the transmission of data.

According to an embodiment of the method 700, the sub-channel is a communication setup channel.

According to an embodiment of the method 700, the sub-channel is a paging channel.

According to an embodiment, the method 700 is carried out by a satellite-based radio communication device.

According to an embodiment, the method 700 is carried out by a mobile radio communication device.

According to an embodiment, the method 700 is carried out by a mobile radio base station.

According to an embodiment of the method 700, the data are transmitted in accordance with a Third Generation Partnership Project communication system.

According to an embodiment of the method 700, the data are transmitted in accordance with a Universal Mobile Telecommunications System communication system.

According to an embodiment of the method 700, the data are transmitted in accordance with a Long Term Evolution Universal Mobile Telecommunications System communication system.

According to an embodiment of the method 700, the data are received in a predetermined receiving mode.

According to an embodiment of the method 700, the data are received in an Idle mode.

According to an embodiment of the method 700, the data are decoded using cyclic prefixes which the date contain.

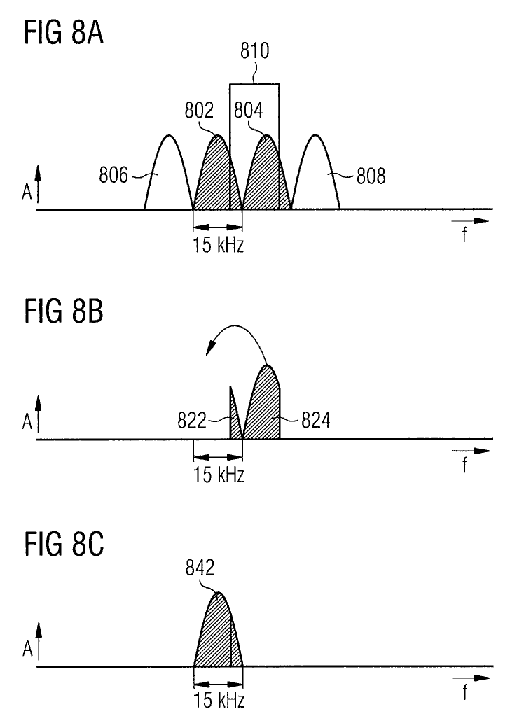

A first example of the invention is shown in FIG. 8. In this example, the paging channel is transmitted on two directly neighboring physical channels 802, 804.

FIG. 8A shows the physical paging channels 802, 804, neighbor channels 806, 808 and a reception window 810 with a frequency error. The data to be transmitted is encoded and transmitted in both, paging channel 802 and paging channel 804. The bandwidth of each of the channels and of the reception window is 15 kHz. In this example, the channels are directly adjacent to each other, i.e. there is no frequency gap inbetween.

FIG. 8B shows the filtered spectrum 822, 824 of the physical paging channels 802, 804 after reception inside the reception window 810. The frequency deviation is determined, and the right (higher frequency) part 824 is shifted by 7.5 kHz plus the frequency error to the left (lower frequency).

In other words, during reception of the paging channel consisting of the two physical channels 802 and 804, the frequency is shifted by a certain amount to the centre of the two channels 802, 804. For instance, it can be set to the centre between the two channels. For LTE, using a 15 kHz sub-channel spacing, this means, that the paging channel is received on a carrier which is 7.5 kHz higher than the lower 802 of the two paging channels 802, 804. During reception, the 15 kHz channel spacing is maintained, meaning, that the higher part 822 of the lower channel 802 and the lower part 824 of the higher channel 804 are received, see FIG. 8B (practically, the receive bandwidth will be larger than 15 kHz, and the wanted signal is then cut out by digital filters).

Now the frequency offset can be determined by evaluating the known parts of the received signal. In LTE these are the cyclic prefixes (CP). Although they are available in a frequency-shifted form, it should nevertheless be possible to derive a usable estimation of the frequency error.

FIG. 8C shows the reconstructed channel 842. Using this frequency offset information the upper and the lower part of the paging message can be put together, and decoded afterwards.

This process can further be optimized by comparing the received signal (in the form of some bit pattern) with the pattern of a fill paging. A fill paging is sent, if the network has no UE to page (i.e. inform some UE of an incoming call). Since this sort of message is relatively often transmitted by the network, and it does not contain useful information, it is not necessary to fully demodulated and decode this message. A comparison of patterns would filter out such messages, thus saving processing time and preventing battery drain.

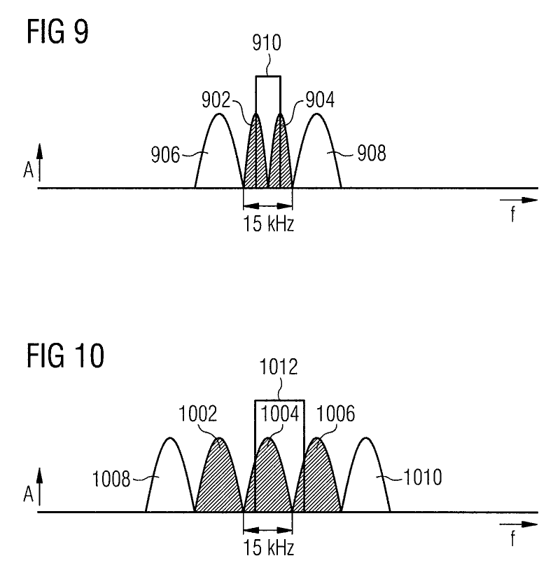

As a second example, alternatively to the duplication of paging channels, the paging channel can be split up into two 7.5 kHz channels, both carrying the same information, of course at a lower bit rate, as illustrated in FIG. 9. FIG. 9 shows a paging message transmitted on two channels 902, 904 with 7.5 kHz bandwidth reception window 910 with frequency error.

The reception process is then in principle the same as above, only the receiver window 910 is 7.5 kHz wide, and it is shifted by 3.75 kHz.

A third example is shown in FIG. 10. According to this alternative the paging messages are transmitted simultaneously on three neighboring channels 1002, 1004, 1006, as illustrated in FIG. 10. The UE then receives the middle of the three channels 1002, 1004, 1006, with a receiver bandwidth of 15 kHz, but without intentional frequency shift. A frequency error would then lead to a partial reception of the channel immediately above or below the middle channel. Processing of the received signal then continues as described above.

As a fourth example beeing a further alternative to the examples above, would be not to transmit on the channels neighboring the paging channel. The UE would then use a wider reception window (>15 kHz), so as to catch the wanted signal regardless of the maximum frequency error. A negative effect of this solution would be that, depending on environmental conditions, beside the wanted signal a big amount of noise and interfering signals is also received, which could make the decoding of the paging message difficult.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A radio communication device, comprising:
a data generating circuit configured to generate data to be transmitted; and
a transmitter circuit configured to transmit the data in a first frequency portion and to transmit at least partially the same data in a second frequency portion being adjacent to the first frequency portion.

2. The radio communication device of claim 1,
wherein the data generating circuit is a message generating circuit configured to generate at least one message comprising the data to be transmitted.

3. The radio communication device of claim 1,
wherein the data generating circuit is further configured to generate at least one communication setup message, and
wherein the data comprise communication setup data.

4. The radio communication device of claim 3,
wherein the data generating circuit is configured to generate at least one paging message, and
wherein the data comprise paging data.

5. The radio communication device of claim 1,
wherein the transmitter circuit is further configured to transmit the data in accordance with a multi-frequency carrier method.

6. The radio communication device of claim 5,
wherein the transmitter circuit is further configured to transmit the data in accordance with a frequency division multiple access method.

7. The radio communication device of claim 1,
wherein the first frequency portion and the second frequency portion are paging channels.

8. The radio communication device of claim 1,
wherein the transmitter circuit is further configured to transmit at least partially the same data in a third frequency portion being adjacent to the first frequency portion or the second frequency portion.

9. A radio communication device, comprising:
a receiver circuit configured to receive data in a first frequency portion and in a second frequency portion being adjacent to the first frequency portion; and
a decoder circuit configured to decode the data received in the first frequency portion and in the second frequency portion such that by consolidating the received data in the first frequency portion and in the second frequency portion, decoded data are determined.

10. The radio communication device of claim 9,
wherein the receiver circuit is a message receiver circuit configured to receive at least one message comprising the data.

11. The radio communication device of claim 9,
wherein the data comprise communication setup data.

12. The radio communication device of claim 11,
wherein the data comprise paging data.

13. The radio communication device of claim 9,
wherein the receiver circuit is further configured to receive the data in accordance with a multi-frequency carrier method.

14. The radio communication device of claim 13,
wherein the receiver circuit is further configured to receive the data in accordance with a frequency division multiple access method.

15. The radio communication device of claim 9,
wherein the first frequency portion and the second frequency portion are paging channels.

16. The radio communication device of claim 9,
wherein the receiver circuit is further configured to receive data in a third frequency portion being adjacent to the first frequency portion or the second frequency portion.

17. A radio communication device, comprising:
a receiver circuit configured to receive data in a frequency portion that is larger than a frequency portion being assigned for the transmission of data; and
a decoder circuit configured to decode the data received in the frequency portion such that by consolidating the received data in the frequency portion, decoded data are determined.

18. The radio communication device of claim 17,
wherein the receiver circuit is a message receiver circuit configured to receive at least one message comprising the data.

19. The radio communication device of claim 17,
wherein the data comprise communication setup data.

20. The radio communication device of claim 19,
wherein the data comprise paging data.

21. The radio communication device of claim 17,
wherein the receiver circuit is further configured to receive the data in accordance with a multi-frequency carrier method.

22. The radio communication device of claim 21,
wherein the receiver circuit is further configured to receive the data in accordance with an orthogonal frequency division multiple access method.

23. The radio communication device of claim 17,
wherein the frequency portion being assigned for the transmission of data is a sub-channel of a frequency channel comprising the frequency portion being assigned for the transmission of data.

24. A method for transmitting data, the method comprising:
generating data to be transmitted;
transmitting the data in a first frequency portion; and
transmitting at least partially the same data in a second frequency portion being adjacent to the first frequency portion.

25. A method for decoding data, the method comprising:
receiving data in a first frequency portion and in a second frequency portion being adjacent to the first frequency portion; and
decoding the data received in the first frequency portion and in the second frequency portion such that by consolidating the received data in the first frequency portion and in the second frequency portion, decoded data are determined.
